(19) United States
(12) Patent Application Publication
(10) Pub. No.: US 2025/0391923 A1
(43) Pub. Date: Dec. 25, 2025

(54) ELASTIC SHEET FOR ALL-SOLID-STATE BATTERY, AND ALL-SOLID-STATE BATTERY COMPRISING SAME

(71) Applicant: SAMSUNG SDI CO., LTD., Yongin-si, Gyeonggi-do (KR)

(72) Inventors: Byeongdo KWAK, Yongin-si, Gyeonggi-do (KR); Ik Hwan CHO, Yongin-si, Gyeonggi-do (KR); Eungyeong LEE, Yongin-si, Gyeonggi-do (KR); Jinhwan PARK, Yongin-si, Gyeonggi-do (KR)

(73) Assignee: SAMSUNG SDI CO., LTD., Yongin-si, Gyeonggi-do (KR)

(21) Appl. No.: 18/880,239

(22) PCT Filed: Nov. 3, 2023
(86) PCT No.: PCT/KR2023/017511

§ 371 Date: Dec. 30, 2024

(30) Foreign Application Priority Data
Nov. 8, 2022 (KR) 10-2022-0148074

(51) Int. Cl. H01M 10/0585; B32B 27/08; B32B 27/30; B32B 27/40; H01M 50/14

(52) U.S. Cl. CPC H01M 10/0585; B32B 27/08; B32B 27/308; B32B 27/40; H01M 50/14; B32B 2250/03; B32B 2250/24; B32B 2307/51; B32B 2307/56; B32B 2307/7376; B32B 2457/10

(57) ABSTRACT

The present invention relates to an elastic sheet for an all-solid-state battery, and the elastic sheet for an all-solid-state battery has a Δ Tan δ value of 0.12 or greater and less than 40.

### CROSS-REFERENCE TO RELATED APPLICATION

The present application is a National Stage Application of PCT International Application No.: PCT/KR2023/017511 filed on Nov. 3, 2023, which claims priority to Korean Patent Application 10-2022-0148074, filed in the Korean Intellectual Property Administration on Nov. 8, 2022, the disclosure of which is incorporated herein by reference in its entirety.

### TECHNICAL FIELD

An elastic sheet for an all-solid-state battery and an all-solid-state battery including the same are disclosed.

### BACKGROUND ART

Recently, the rapid supplement of electronic devices such as mobile phones, laptop computers, and electric vehicles, using batteries require surprising increases in demands for rechargeable batteries with relatively high capacity and lighter weight. Particularly, a rechargeable lithium battery has recently drawn attention as a driving power source for portable devices, as it has lighter weight and high energy density. Accordingly, research and development to improve the performance of rechargeable lithium batteries is being actively conducted.

An all-solid-state battery among rechargeable lithium batteries refers to a battery in which all materials are solid, and in particular, a battery using a solid electrolyte. This solid electrolyte is located between the positive and negative electrodes, preventing direct contact between the positive and negative electrodes while acting as a passage through which lithium ions move during the charge and discharge process. At this time, if the solid electrolyte is damaged or the interface between the positive electrode and the solid electrolyte or the interface between the negative electrode and the solid electrolyte is not in close contact, the movement of lithium becomes difficult, causing the battery to not work or its cycle-life to be reduced.

To maintain a close-contacting force between the electrodes and the solid electrolyte, the battery is fabricated by fixing the solid-state battery while pressing inward at both ends. The force applied at this time is transmitted to the solid electrolyte through the negative electrode and positive electrode, compressing the solid electrolyte. If too much force is applied, cracks may occur in the solid electrolyte, reducing the movement of lithium ions and, in severe cases, making battery charging and discharging impossible.

In addition, while charging and discharging an all-solid-state battery, the negative electrode undergoes repeated shrinkage and expansion, and if the expanded negative electrode may not shrink back to its original thickness, the movement speed of lithium ions gradually decreases, which may lower the discharge efficiency.

### Technical Problem

An embodiment provides an elastic sheet for an all-solid-state battery that may absorb external force applied from the outside during charging and discharging and has excellent restoring power during charging and discharging.

Another embodiment provides an all-solid-state battery including the elastic sheet.

### Technical Solution

An embodiment provides an elastic sheet for an all-solid-state battery having a Δ Tan δ value of greater than or equal to 0.12 and less than 0.40, as defined by Equation 1.

$$Δ Tan δ = Tan {δ}_{T = 25} - Tan {δ}_{T = 45} \qquad [ Equation 1 ]$$

In Equation 1, Tan δ_{T=25} is E″/E′ at 25° C., wherein E″ is the loss modulus and E′ is the storage modulus, and
Tan δ_{T=45} is E″/E′ at 45° C., wherein E″ is the loss modulus and E′ is the storage modulus.

The Δ Tan δ value may be greater than or equal to 0.12 and less than 0.34.

The elastic sheet may include an acrylic resin, a urethane-based resin, a silicone resin, or a combination thereof.

The elastic sheet may have a single-layer structure. Alternatively, the elastic sheet may have a multilayer structure. According to an embodiment, the elastic sheet may include a first layer including an acrylic resin, and a second layer including a urethane-based resin and a third layer including a urethane-based resin on both surfaces of the first layer.

A thickness ratio of the first layer and (a total thickness of the second layer and the third layer) may be 1:4 to 1:6.

Another embodiment provides an all-solid-state battery including a positive electrode; a negative electrode; a solid electrolyte layer between the positive electrode and the negative electrode; and the elastic sheet on an outer surface of at least one of the positive electrode and the negative electrode.

### Advantageous Effects

The elastic sheet for an all-solid-state battery according to an embodiment may absorb external force well, disperse the force applied to a solid electrolyte, and exhibit excellent restoring force during a charge and discharge process.

### BRIEF DESCRIPTION OF THE DRAWINGS

FIG. 1 is a schematic view illustrating an all-solid-state battery according to an embodiment.

FIG. 2 is a schematic cross-sectional view schematically illustrating an all-solid-state battery according to another embodiment.

### DETAILED DESCRIPTION OF THE INVENTION

Hereinafter, embodiments of the present invention will be described in detail. However, these embodiments are merely examples, the present invention is not limited thereto, and the present invention is defined by the scope of claims.

The terminology used herein is used to describe embodiments only, and is not intended to limit the present disclosure. Expressions in the singular include a plurality of expressions unless the context clearly dictates otherwise.

As used herein, “combination thereof” means a mixture, a laminate, a composite, a copolymer, an alloy, a blend, a reaction product, and the like of the constituents.

The term “comprise,” “include” or “have” are intended to designate that the performed characteristics, numbers, step, constituted elements, or a combination thereof is present, but it should be understood that the possibility of presence or addition of one or more other characteristics, numbers, steps, constituted element, or a combination do not be precluded in advance.

As used herein, when specific definition is not otherwise provided, it will be understood that when an element such as a layer, film, region, or substrate is referred to as being “on” another element, it may be directly on the other element or intervening elements may also be present.

In the present invention, “particle size” or “particle diameter” may be an average particle diameter. Additionally, the average particle diameter may be defined as the average particle diameter (D50) based on 50% of the cumulative volume in the cumulative size-distribution curve. The particle diameter may be, for example, measured by an electron microscopy examination using a scanning electron microscopy (SEM) or a field emission scanning electron microscopy (FE-SEM), or a laser diffraction method. It may be measured by the laser diffraction method as follows, and the particles to be measured are dispersed in a dispersion medium and then introduced into a commercially available laser diffraction particle size measuring apparatus (for example, MT 3000 of Microtrac, Inc.), ultrasonic waves of about 28 kHz are irradiated with an output of 60 W, and an average particle diameter (D50) in 50% reference of the particle size distribution in a measuring apparatus may be calculated.

An embodiment relates to an elastic sheet for an all-solid-state battery. The elastic sheet may be referred to as a buffer layer or an elastic layer. This elastic sheet ensures that pressure is uniformly transmitted to an electrode stack of the negative electrode, solid electrolyte, and positive electrode, thereby improving contact between the solid components and also alleviating stress transmitted to the solid electrolyte, etc. In addition, the elastic sheet may play a role in suppressing cracks from occurring in the solid electrolyte due to stress accumulation according to changes in the thickness of the electrode during charging and discharging.

An elastic sheet for an all-solid-state battery according to an embodiment is an elastic sheet having a Δ Tan δ value of greater than or equal to 0.12 and less than 0.40, as defined by Equation 1.

$$Δ Tan δ = Tan {δ}_{T = 25} - Tan {δ}_{T = 45} \qquad [ Equation 1 ]$$

In Equation 1, Tan δ_{T=25} is E″/E′ at 25° C., wherein E″ is the loss modulus and E′ is the storage modulus, and
Tan δ_{T=45} is E″/E′ at 45° C., wherein E″ is the loss modulus and E′ is the storage modulus. E″/E′ is referred to tan delta.

That is, Δ Tan δ means a difference between tan delta at 25° C. and tan delta at 45° C.

In an embodiment, the Δ Tan δ value is a property value of the elastic sheet itself, and is a value that is maintained even if a formation charge/discharge is performed.

The loss modulus refers to the energy (elasticity) lost if pressure or heat is applied, and the storage modulus refers to the energy stored without loss due to elasticity even if pressure or heat is applied. The higher the storage modulus, the closer it is to a perfectly elastic body, like a spring, and the higher the loss modulus, the more it may exhibit behavior similar to water.

The loss modulus and storage modulus may be obtained using dynamic mechanical analysis (DMA). The measuring method may include, for example, cutting an elastic sheet into a width of a certain size, placing the sample between two jigs with a predetermined interval, and applying a force to the jigs to fix the sample. At this time, a gap between two jigs may be about 10 mm to 20 mm, 11 mm to 15 mm, or 11 mm to 13 mm.

Next, the storage modulus (E′) and loss modulus (E″) for each temperature are measured while increasing the temperature from −40° C. to 80° C. at a rate of 5° C./min under the conditions of strain 0.15% and frequency 1 Hz, and among them, the loss modulus and storage modulus at 25° C. and 45° C. are used to obtain the Tan delta value.

The storage modulus and loss modulus were measured using a TA dynamic mechanical analyzer (model name: Q800DMA).

The elastic sheet according to an embodiment has properties that appropriately control the relationship between the loss modulus and the storage modulus measured at room temperature, i.e., 25° C., which is a typical battery fabricating temperature, and the loss modulus and the storage modulus measured at the battery charge/discharge temperature, i.e., 45° C.

At 25° C. which is the battery fabricating process, unexpected impacts may occur during the assembly or pressing process. At this time, if the storage modulus of the elastic sheet is low and the loss modulus is high, that is, if the Tan delta is high, the external impact is not transmitted to the battery, but is absorbed and dispersed, thereby protecting the battery.

On the other hand, at 45° C., which is the charge/discharge temperature of the battery, a restoring force is required to return the elastic sheet to its original position in order to maintain a close-contacting force at the interface between the positive electrode and the electrolyte and the interface between the electrolyte and the negative electrode despite repeated shrinkage and expansion. That is, at 45° C., the higher the storage modulus and the lower the loss modulus, that is, the lower the Tan delta, the better the battery charging/discharging.

Considering these properties, as a difference between tan delta at 25° C. and tan delta at 45° C. increases, it is desirable, but according to one embodiment, this difference, Δ Tan δ in Equation 1, is appropriately greater than or equal to 0.12 and less than 0.40. In another embodiment, Δ Tan δ of Equation 1 may be greater than or equal to 0.12 and less than 0.34, and may be 0.12 to 0.29.

If Δ Tan δ is less than 0.12, in the process of applying pressure to bring the interface between the positive electrode and the solid electrolyte and the interface between the negative electrode and the solid electrolyte into close contact, the restoring force of the elastic sheet may cause to insufficient close contact, and thus, the battery may not operate or the battery cycle-life may be deteriorated. In addition, if Δ Tan δ is less than 0.12, if a very large pressure is applied to solve the problem of restoring the low elastic sheet, excessive force is applied to the positive electrode, negative electrode, or solid electrolyte, which may cause pressing or cracking, shortening the battery cycle-life or causing it to not work as a battery, which is not appropriate.

If Δ Tan δ exceeds 0.40, a relatively large force may be applied during the applying pressure into close contact, which may reduce the phenomenon of the battery not working, but the restoring force is not good, and thus the adhesive force decreases rapidly during the charge/discharge process, shortening the battery cycle-life, which is not suitable.

In an embodiment, Tan δ at 2° C. may be greater than or equal to 0.2, greater than or equal to 0.35, or greater than or equal to 0.37.

In particular, in an embodiment, the Δ Tan δ value only needs to be greater than or equal to 0.12 and less than or equal to 0.40, and there is no need to limit Tan δ at 25° C. and Tan δ at 45° C., respectively.

An elastic sheet according to an embodiment may include an acrylic resin, a urethane-based resin, a silicone resin, or a combination thereof.

The acrylic resin may be a homopolymer or copolymer derived from (meth)acrylic acid or acrylate monomer. In an embodiment, (meth)acrylic acid means acrylic acid or methacrylic acid.

The acrylate monomer may be a hydroxyl group-containing acrylate, a reactive (meth)acrylate, or a combination thereof.

A weight average molecular weight (Mw) of the acrylic resin may be from 1,000,000 to 3,000,000, but is not limited thereto.

The urethane-based resin may include, but is not limited to, a urethane rubber, polyurethane, or a combination thereof, and any resin including a urethane bond (—NH—CO—) may be used. A weight average molecular weight of the urethane-based resin may be from 400,000 to 800,000, but is not limited thereto.

In an embodiment, the elastic sheet may have a multilayer structure of three or more layers, or may have a single-layer structure. In another embodiment, the elastic sheet may have a multilayer structure of three or more layers.

If the elastic sheet has a multilayer structure, it may include an acrylic resin-containing layer and a urethane-based resin layer on both surfaces of the acrylic resin-containing layer. For example, the elastic sheet may include a first layer including an acrylic resin, and a second layer and a third layer formed on both surfaces of the acrylic resin-containing layer and including a urethane-based resin.

If the elastic sheet has a multilayer structure, the thickness of the acrylic resin-containing layer and the urethane-based resin layer may be appropriately adjusted so that Δ Tan δ″ of Equation 1 of the elastic sheet is obtained. For example, the thickness ratio of the first layer to (the total thickness of the second layer and the third layer) may be 1:4 to 1:6, or may be 1:5 to 1:6. If the thickness ratio (the total thickness of the second layer and the third layer) to the thickness of the first layer is less than 3/1 or greater than 6/1, the Δ Tan δ value of Equation 1 may be less than 0.12 or greater than or equal to 0.40, which is not appropriate.

At this time, as long as the ratio of the thickness of the first layer and (the total thickness of the second and third layers) is within the above range, that is, as long as the thickness ratio of the acrylic resin-containing layer and the urethane-based resin layer is within the above range, there is no need to limit the thickness ratio between the second and third layers, which are urethane-based resin layers.

Regardless of whether the elastic sheet has a single-layer structure or a multilayer structure, the thickness of the elastic sheet may be 200 μm to 800 μm, 200 μm to 600 μm, or 200 μm to 400 μm.

If the thickness of the elastic sheet is within the above range, there is no need to limit the thickness of each of the first, second, and third layers even if the elastic sheet has a multilayer structure. That is, as long as the thickness of the elastic sheet is within the above range and the ratio of the thickness of the first layer to (the total thickness of the second and third layers) is within the above range, the thicknesses of each of the first, second and third layers may be appropriately adjusted.

In the case where the elastic sheet according to an embodiment has a single-layer structure, the layer is manufactured by mixing an acrylic resin and a urethane-based resin in a weight ratio of 1:4 to 1:6, and the weight average molecular weight (Mw) of the acrylic resin and the urethane-based resin is 1,000,000 to 3,000,000, so that the Δ Tan δ value of Equation 1 may be greater than or equal to 0.12 and less than 0.40.

In addition, the elastic sheet having a single-layer structure according to an embodiment may also be manufactured by mixing an initiator into a monomer mixture including a hydroxyl group-containing (meth)acrylate monomer and a reactive (meth)acrylate monomer, and then irradiating it with UV. At this time, a weight average molecular weight (Mw) of the (meth)acrylic copolymer may be 1 million to 3 million.

The initiator may be a radical type photopolymerization initiator, and may be present in an amount of 1 part by weight to 5 parts by weight, specifically 0.05 parts by weight to 3 parts by weight, or more specifically 0.1 parts by weight to 1 parts by weight, based on 100 parts by weight of the hydroxyl group-containing (meth)acrylic copolymer.

Additionally, in the mixing process, a crosslinking agent may be further used. The crosslinking agent may be a multifunctional (meth)acrylate, for example bifunctional acrylate such as 1,4-butanediol di(meth)acrylate, 1,6-hexanediol di(meth)acrylate, neopentylglycol di(meth)acrylate, polyethylene glycol di(meth)acrylate, neopentylglycol adipate di(meth)acrylate, dicyclopentanyl di(meth)acrylate, caprolactone modified dicyclopentenyl di(meth)acrylate, ethyleneoxide modified di(meth)acrylate, di(meth)acryloxyethyl isocyanurate, allylated cyclohexyl di(meth)acrylate, tricyclodecanedimethanol (meth)acrylate, dimethylol dicyclopentane di(meth)acrylate, ethyleneoxide modified hexahydrophthalic acid di(meth)acrylate, tricyclodecane dimethanol (meth)acrylate, neopentyl glycol modified trimethylpropane di(meth)acrylate, adamantane di(meth)acrylate, or 9,9-bis[4-(2-acryloyloxyethoxy)phenyl]fluorene; trifunctional acrylate such as trimethylolpropane tri(meth)acrylate, dipentaerythritol tri(meth)acrylate, propionic acid modified dipentaerythritol tri(meth)acrylate, pentaerythritol tri(meth)acrylate, propylene oxide modified trimethylolpropane tri(meth)acrylate, trifunctional urethane (meth)acrylate, tris(meth)acryloxyethylisocyanurate, and the like; tetrafunctional acrylate such as diglycerin tetra(meth)acrylate or pentaerythritoltetra(meth)acrylate, and the like; pentafunctional acrylate such as dipentaerythritol penta(meth)acrylate, and the like; and hexafunctional acrylate such as dipentaerythritol hexa(meth)acrylate, caprolactone modified dipentaerythritol hexa(meth)acrylate, and the like, and the like, but is not limited thereto. These may be used alone or in combination of two or more. Specifically, the crosslinking agent may have excellent durability and reliability by using a polyfunctional (meth)acrylate of a polyhydric alcohol having 2 to 20 hydroxyl groups.

The crosslinking agent may be included in an amount of 0.001 part by weight to 1 part by weight, specifically 0.03 part by weight to 0.7 part by weight, specifically 0.1 part by weight to 0.5 part by weight, based on 100 parts by weight of the hydroxyl group-containing (meth)acrylic copolymer.

The elastic sheet may further include additives. The additive may be a conventional additive such as a coupling agent, a curing accelerator, ionic liquid, a lithium salt, inorganic filler, a softening agent, a molecular weight regulator, an antioxidant, an anti-aging agent, a stabilizer, a tackifier resin, a flame retardant, a modified resin (a polyol resin, a phenol resin, an acrylic resin, a polyester resin, a polyolefin resin, an epoxy resin, an epoxidized polybutadiene resin, and the like), a leveling agent, an antifoaming agent, a plasticizer, a dye, a pigment (coloring pigment, a extender pigment, and the like), a treating agent, an ultraviolet ray blocker, a fluorescent whitening agent, a dispersant, a heat stabilizer, a light stabilizer, an ultraviolet ray absorber, an antistatic agent, a coagulant, a lubricant and a solvent, and the like.

The thickness of the elastic sheet according to an embodiment may be from 100 μm to 800 μm, for example from 100 μm to 600 μm, or from 150 μm to 500 μm. In this thickness range, the elastic sheet may sufficiently relieve stress due to pressing and stress due to thickness change during charging and discharging, and may exhibit excellent restoring force.

Another embodiment provides an all-solid-state battery including the elastic sheet. The all-solid-state battery includes a positive electrode; a negative electrode; a solid electrolyte layer between the positive electrode and the negative electrode and an elastic sheet on an outer surface of at least one of the positive electrode and the negative electrode.

The elastic sheet may be located on the outermost layer surface of the electrode assembly, or in a structure in which two or more electrode assemblies are stacked, may be located on the outermost layer and/or inside the assembly. Considering that the thickness of the negative electrode changes significantly during charge and discharge, especially due to dendrite formation, the elastic sheet may buffer problems due to thickness changes by being located on the outer surface of the negative electrode, that is, on the opposite surface of the negative electrode where the solid electrolyte layer is in contact. In addition, the elastic sheet may be located on the outer surface of the positive and/or negative electrodes to prevent the phenomenon of deterioration by reaction with lithium, thereby increasing the coulombic efficiency of the battery.

The positive electrode includes a current collector and a positive electrode active material layer on at least one surface of the current collector. The positive electrode active material layer includes a positive electrode active material and a sulfide-based solid electrolyte, and may optionally include a binder and/or a conductive material.

The positive electrode active material may be a positive electrode active material capable of reversibly intercalating and deintercalating lithium ions. For example, the positive electrode active material may be, for example, at least one of a composite oxide of lithium and a metal selected from cobalt, manganese, nickel, and a combination thereof. Examples of the positive electrode active material may include LiₐA_{1-b}B¹_{b}D¹₂ (0.90≤a≤1.8, 0≤b≤0.5); LiₐE_{1-b}B¹_{b}O_{2-c}D¹_{c} (0.90≤a≤1.8, 0≤b≤0.5, 0≤c≤0.5); LiₐE_{2-b}B¹_{b}O_{4-c}D¹_{c} (0.90≤a≤1.8, 0≤b≤0.5, 0≤c≤0.5); LiₐNi_{1-b-c}Co_{b}B¹_{c}D¹_{α} (0.90≤a≤1.8, 0≤b≤0.5, 0≤c≤0.5, 0<α≤2); LiₐNi_{1-b-c}Co_{b}B¹_{c}O_{2-α}F¹_{α} (0.90≤a≤1.8, 0≤b≤0.5, 0≤c≤0.5, 0<α<2); LiₐNi_{1-b-c}Co_{b}B¹_{c}O_{2-α}F¹₂ (0.90≤a≤1.8, 0≤b≤0.5, 0≤c≤0.5, 0<α<2); LiₐNi_{1-b-c}Mn_{b}B¹_{c}D¹_{α} (0.90≤a≤1.8, 0≤b≤0.5, 0≤c≤0.5, 0<α≤2); LiₐNi_{1-b-c}Mn_{b}B¹_{c}O_{2-α}F¹_{α} (0.90≤a≤1.8, 0≤b≤0.5, 0≤c≤0.5, 0<α<2); LiₐNi_{1-b-c}Mn_{b}B¹_{c}O_{2-α}F¹₂ (0.90≤a≤1.8, 0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.01≤b≤0.1); LiₐMnG_{b}O₂ (0.90≤a≤1.8, 0.001≤b≤0.1); LiₐMn₂G_{b}O₄ (0.90≤a≤1.8, 0.001≤b≤0.1); QO₂; QS₂; LiQS₂; V₂O₅; LiV₂O₅; LiI¹O₂; LiNiVO₄; Li_{(3-f)}J₂(PO₄)₃ (0≤f≤2); Li_{(3-f)}Fe₂(PO₄)₃ (0≤f≤2); or LiFePO₄.

In the above chemical formulas, A is Ni, Co, Mn, or a combination thereof; B¹ is Al, Ni, Co, Mn, Cr, Fe, Mg, Sr, V, a rare-earth element, or a combination thereof; D¹ is O, F, S, P, or a combination thereof; E is Co, Mn, or a combination thereof; F¹ is F, S, P, or a combination thereof; G is Al, Cr, Mn, Fe, Mg, La, Ce, Sr, V, or a combination thereof; Q is Ti, Mo, Mn, or a combination thereof; I¹ is Cr, V, Fe, Sc, Y, or a combination thereof; J is V, Cr, Mn, Co, Ni, Cu, or a combination thereof; and L¹ is Mn, Al, or a combination thereof.

Also, the compounds may have a coating layer on the surface, or may be mixed with another compound having a coating layer. The coating layer may include at least one coating element compound selected from an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Li, Mg, Al, Co, K, Na, Ca, Si, Ti, V, Sn, Ge, Ga, B, As, Zr, or a combination thereof. As an example, the coating layer may include lithium zirconium oxide, for example, Li₂O—ZrO₂. The coating layer formation process may be performed using a method that does not adversely affect the properties of the positive electrode active material, such as spray coating or dipping.

The positive electrode active material may include, for example, one or more of a lithium-metal composite oxide represented by Chemical Formula 11.

$${Li}_{a} {{M}^{11}}_{1 - y 11 - z 11} {{M}^{12}}_{y 11} {{M}^{13}}_{z 11} {O}_{2} \qquad [ Chemical Formula 11 ]$$

In Chemical Formula 11, 0.9≤a≤1.8, 0≤y11≤1, 0≤z11≤1, 0≤y11+z11<1, and M¹¹, M¹², and M¹³ are each independently at least one element selected from Ni, Co, Mn, Al, Mg, Ti, and Fe, and a combination thereof.

For example, M¹¹ may be Ni, and M¹² and M¹³ may each independently be a metal such as Co, Mn, Al, Mg, Ti, or Fe. In a specific embodiment, M¹¹ may be Ni, M¹² may be Co, and M¹³ may be Mn or Al, but they are not limited thereto.

In an embodiment, the positive electrode active material may include a lithium nickel-based composite oxide represented by Chemical Formula 12.

$${Li}_{a 12} {Ni}_{x 12} {{M}^{14}}_{y 12} {{M}^{15}}_{1 - y 12 - z 12} {O}_{2} \qquad [ Chemical Formula 12 ]$$

In Chemical Formula 12, 0.9≤a12≤1.8, 0.3≤x12≤1, 0≤y12≤0.7, and M¹⁴ and M¹⁵ are each independently at least one element selected from Al, B, Ba, Ca, Ce, Co, Cr, F, Fe, Mg, Mn, Mo, Nb, P, S, Si, Sr, Ti, V, W, and Zr.

The positive electrode active material may include, for example, a lithium nickel cobalt-based oxide represented by Chemical Formula 13.

$${Li}_{a 13} {Ni}_{x 13} {Co}_{y 13} {{M}^{16}}_{1 - x 13 - y 13} {O}_{2} \qquad [ Chemical Formula 13 ]$$

in Chemical Formula 13, 0.9≤a13≤1.8, 0.3≤x13<1, 0<y13≤0.7, and M¹⁶ is at least one element selected from Al, B, Ba, Ca, Ce, Cr, F, Fe, Mg, Mn, Mo, Nb, P, S, Si, Sr, Ti, V, W, and Zr.

In Chemical Formula 13, 0.3≤x13≤0.99 and 0.01≤y13≤0.7, 0.4≤x13≤0.99 and 0.01≤y13≤0.6, or 0.5≤x13≤0.99 and 0.01≤y13≤0.5, or 0.6≤x13≤0.99 and 0.01≤y13≤0.4, or 0.7≤x13≤0.99 and 0.01≤y13≤0.3, 0.85≤x13≤0.99 and 0.01≤y13≤0.2, or 0.95≤x13≤0.99 and 0.01≤y13≤0.1.

In the lithium nickel-based composite oxide, an amount of nickel may be greater than or equal to 30 mol %, for example greater than or equal to 40 mol %, greater than or equal to 50 mol %, greater than or equal to 60 mol %, greater than or equal to 70 mol %, greater than or equal to 80 mol %, or greater than or equal to 90 mol % and less than or equal to 99.9 mol % or less than or equal to 99 mol % based on the total amount of metals excluding lithium. For example, in the lithium nickel-based composite oxide, the amount of nickel may be higher than that of each of the other metals such as cobalt, manganese, aluminum, and the like. If the amount of nickel satisfies the ranges, the positive electrode active material may realize high capacity and exhibit excellent battery performance.

The solid electrolyte may be a sulfide-based solid electrolyte, an oxide-based solid electrolyte, or a combination thereof.

The positive electrode active material may have an average particle diameter of 1 μm to 25 μm, for example 4 μm to 25 μm, 5 μm to 20 μm, 8 μm to 20 μm, or 10 μm to 18 μm. The positive electrode active material having a particle diameter within the ranges may be harmoniously mixed with the other components in the positive electrode active material layer and realize high capacity and high energy density.

The positive electrode active material may be in the form of secondary particles formed by aggregating a plurality of primary particles, or may be in the form of single particles. In addition, the positive electrode active material may have a spherical or near-spherical shape, or may have a polyhedral or irregular shape.

Based on the total weight of the positive electrode active material layer, the positive electrode active material may be included in an amount of 55 wt % to 99.7 wt %, for example 74 wt % to 89.8 wt %. If included in the above range, the capacity of the all-solid-state battery may be maximized while improving cycle-life characteristics.

The above solid electrolyte may be an inorganic solid electrolyte such as a sulfide-based solid electrolyte, an oxide-based solid electrolyte, or a solid polymer electrolyte.

In an embodiment, the solid electrolyte may be a sulfide-based solid electrolyte with excellent ionic conductivity. The sulfide-based solid electrolyte may be, for example, L₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, L₂S—B₂S₃, Li₂S—P₂S₅—ZₘSₙ (wherein m and n are each integer and Z is Ge, Zn, or Ga), Li₂S—GeS₂, Li₂S—SiS₂—Li₃PO₄, Li₂S—SiS₂-Li₆MO_{q} (wherein p and q are each integer and M is P, Si, Ge, B, Al, Ga, or In).

The sulfide-based solid electrolyte may be obtained by, for example, mixing Li₂S and P₂S₅ in a mole ratio of 50:50 to 90:10 or 50:50 to 80:20. Within the above mixing ratio range, a sulfide-based solid electrolyte having excellent ionic conductivity may be prepared. The ionic conductivity may be further improved by adding SiS₂, GeS₂, B₂S₃, and the like as other components thereto. As a mixing method, mechanical milling or a solution method may be applied. Mechanical milling is a method in which the starting materials and the ball mill are put in the reactor and stirred vigorously to micronize the starting materials to mix them. In the case of using the solution method, a solid electrolyte may be obtained as a precipitate by mixing the starting materials in a solvent. In addition, firing may be additionally performed after mixing. If additional firing is performed, crystals of the solid electrolyte may become more rigid.

For example, the solid electrolyte may be an argyrodite-type sulfide-based solid electrolyte. The sulfide-based solid electrolyte may be, for example, LiₐM_{b}P_{c}S_{d}A_{c} (wherein a, b, c, d and e are all 0 or more and 12 or less, but a, b, c, d, and e are not all 0, and M is Ge, Sn, Si, or a combination thereof, A is F, Cl, Br, or I), and specifically, Li₃PS₄, Li₂P₃S₁₁, Li₄PS₅Cl, Li₆PS₅Br, Li₆PS₅I, etc. The sulfide-based solid electrolyte has high ionic conductivity close to the ionic conductivity of general liquid electrolytes at room temperature, which is in the range of 10⁻⁴ S/cm to 10⁻² S/cm, and thus may form a close bond between the active material and the solid electrolyte without causing a decrease in ionic conductivity, and further, may form a close interface between the electrode layer and the solid electrolyte layer. An all-solid-state battery including the same may have improved battery performances such as rate capability, coulombic efficiency, and cycle-life characteristics.

The sulfide-based solid electrolyte may be amorphous or crystalline, or may be a mixture of the two. Of course, a commercially available solid electrolyte may be used as the sulfide-based solid electrolyte.

The oxide-based solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB(MgS₃Nb₃)O₃—PbTiO₃ (PMN-PTr), HfM₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; x is an integer of 1 to 10), or a mixture thereof.

The solid polymer electrolyte may include, for example, one or more selected from polyethylene oxide, poly(diallyldimethylammonium) trifluoromethanesulfonylimide (poly(diallyldimcthylammonium)TFSI), CuN, Li₃N, UPON, Li₃PO₄·Li₂S·SiS₂, Li₂S·GeS₂·Ga₂S₃, Li₂O·11Al₂O₃, Na₂O·11Al₂O₃, (Na,Li)₁₊ₓTi₂₋ₓAl(PO₄)₃ (0.1≤x≤0.9), Li₁₊ₓHf₂₋ₓAlₓ(PO₄)₃ (0.1≤x≤0.9), Na₃Zr₂Si₂PO₁₂, Li₄Zr₂Si₂PO₁₂, Na₅ZrP₃O₁₂, Na₅TiP₃O₁₂, NaFe₂P₃O₁₂, Na₄NbP₃O₁₂, Na-Silicates, Li_{0.3}La_{0.5}TiO₃, Na₅MSi₄O₁₂ (wherein M is a rare earth element of Nd, Gd, Dy, and the like), Li₅ZrP₃O₁₂, Li₅TiP₃O₁₂, Li₃Fe₂P₃O₁₂, Li₄NbP₃O₁₂, Li₁₊ₓ(M,Al,Ga)ₓ(Ge_{1-y}Ti_{y})₂₋ₓ(PO₄)₃ (x≤0.8, 0≤y≤1.0, and M is Nd, Sm, Eu, Gd, Tb, Dy, Ho, Er, Tm, or Yb), Li_{1+x+y}QₓTi₂₋ₓSi_{y}P_{3-y}O₁₂ (0<x≤0.4, 0<y≤0.6, and Q is Al or Ga), Li₆BaLa₂TaO₁₂, Li₇La₃Zr₂O₁₂, Li₅La₃Nb₂O₁₂, Li₅La₃M₂O₁₂ (M is Nb or Ta), and Li₇₊ₓAₓLa₃₋ₓZr₂O₁₂ (0<x<3, and A is Zn).

The solid electrolyte may in the form of particles, and an average particle diameter (D50) may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The solid electrolyte may effectively penetrate between the positive electrode active materials, and have excellent contact with the positive electrode active materials and connectivity between the solid electrolyte particles.

Based on the total amount of the positive electrode active material layer, an amount of the solid electrolyte may be 0.1 wt % to 35 wt %, for example, 1 wt % to 35 wt %, 5 wt % to 30 wt %, 8 wt % to 25 wt %, or 10 wt % to 20 wt %. In addition, in the positive electrode active material layer, the positive electrode active material may be included in an amount of 65 wt % to 99 wt % and the solid electrolyte in an amount of 1 wt % to 35 wt %, for example, the positive electrode active material may be included in an amount of 80 wt % to 90 wt % and the solid electrolyte in an amount of 10 Wt % to 20 wt % based on the total weight of the positive electrode active material and the solid electrolyte. If the solid electrolyte is included in the positive electrode in such an amount, the efficiency and cycle-life characteristics of the all-solid-state battery may be improved without reducing the capacity.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinyl fluoride, an ethylene oxide-containing polymer, polyvinylpyrrolidone, polyurethane, polytetrafluoroethylene, polyvinylidene fluoride, a vinylidenefluoride-hexafluoropropylene copolymer, polyethylene, polypropylene, a styrene butadiene rubber, an acrylated styrene butadiene rubber, polyacrylonitrile, an epoxy resin, nylon, poly(meth)acrylate, polymethyl(meth)acrylate, and the like, but is not limited thereto.

Among them, the binder according to an embodiment one or more selected from polyvinylidene fluoride, a vinylidene fluoride-hexafluoropropylene copolymer, polytetrafluoroethylene, a styrene butadiene rubber, polyacrylonitrile, and polymethyl (meth) acrylate.

The binder may be included in an amount of 0.1 wt % to 5 wt %, or 0.1 wt % to 3 wt %, based on the total weight of each component of the positive electrode for an all-solid-state battery or the total weight of the positive electrode active material layer. In the above amount range, the binder may sufficiently exhibit adhesive ability without degrading battery performance.

The conductive material is used to provide conductivity to the electrode, and any material that does not cause chemical change and is electronically conductive may be used. The conductive material may include, for example, a carbon-based material such as natural graphite, artificial graphite, carbon black, acetylene black, ketjen black, a carbon fiber, a carbon nanofiber, or a carbon nanotube; a metal-based material including copper, nickel, aluminum, or silver in the form of metal powder or metal fiber; a conductive polymer such as a polyphenylene derivative; or a mixture thereof.

The conductive material may be included in an amount of 0.1 wt % to 5 wt %, or 0.1 wt % to 3 wt %, based on a total weight of each component of the positive electrode for the all-solid-state battery, or based on a total weight of the positive electrode active material layer. Within the above amount range, the conductive material may improve electrical conductivity without deteriorating battery performance.

The current collector may include, for example, indium (in), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The negative electrode includes a current collector and a negative electrode layer on one surface of the current collector.

The negative electrode layer may be a negative electrode active material layer or a negative electrode catalyst layer.

The negative electrode active material layer includes a negative electrode active material and may further include a binder, a conductive material, and/or a solid electrolyte.

The negative electrode active material may be lithium metal. If the negative electrode active material layer includes lithium metal, it may include lithium metal itself or a lithium alloy. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be unspecified shaped, sheet shaped, flake shaped, spherical shaped, or fiber shaped natural graphite or artificial graphite, and the amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may be silicon, a silicon-carbon composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and not Si), and the Sn-based negative electrode active material may be Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, and not Sn) and the like. At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer on the surface of the core. The crystalline carbon may be artificial graphite, natural graphite, or a combination thereof. The above amorphous carbon precursor may be coal-based pitch, mesophase pitch, petroleum-based pitch, coal-based oil, petroleum-based heavy oil, or a polymer resin such as a phenol resin, a furan resin, or a polyimide resin. In this case, the amount of silicon may be 10 wt % to 50 wt % based on the total weight of the silicon-carbon composite. Additionally, an amount of the crystalline carbon may be 10 wt % to 70 wt % based on a total weight of the silicon-carbon composite, and an amount of the amorphous carbon may be 20 wt % to 40 wt % based on a total weight of the silicon-carbon composite. Additionally, the thickness of the amorphous carbon coating layer may be 5 nm to 100 nm.

The average particle diameter (D50) of the silicon particles may be 10 nm to 20 μm, for example, 10 nm to 500 nm. The silicon particles may exist in an oxidized form, and in this case, an atomic amount ratio of Si:O in the silicon particles indicating a degree of oxidation may be a weight ratio of 99:1 to 33:67. The silicon particles may be SiOₓ particles, wherein the range of x in SiOₓ may be greater than 0 and less than 2. Here, the average particle diameter (D50) is measured by a particle size analyzer using laser diffraction and means the diameter of particles with a cumulative 50 volume % in the particle size distribution.

The Si-based negative electrode active material or Sn-based negative electrode active material may be mixed with the carbon-based negative electrode active material. If the Si-based negative electrode active material or Sn-based negative electrode active material and the carbon-based negative electrode active material are mixed and used, the mixing ratio may be a weight ratio of 1:99 to 90:10.

In the negative electrode active material layer, the negative electrode active material may be included in an amount of 95 wt % to 99 wt % based on a total weight of the negative electrode active material layer.

In an embodiment, the negative electrode active material layer further includes the binder and optionally may further include the conductive material. An amount of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may include a water-insoluble binder, a water-soluble binder or a combination thereof.

The water-insoluble binder may include, for example, polyvinylchloride, carboxylated polyvinylchloride, polyvinylfluoride, an ethylene oxide-containing polymer, an ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluorine rubber, and a combination thereof. The polymer resin binder may be selected from polyethylene oxide, polyvinylpyrrolidone, polyepichlorohydrin, polyphosphazene, polyacrylonitrile, ethylene propylene diene copolymer, polyvinyl pyridine, chlorosulfonated polyethylene, latex, a polyester resin, an acrylic resin, a phenol resin, an epoxy resin, polyvinyl alcohol, and a combination thereof.

If a water-soluble binder is used as the above negative binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, an alkali metal salt thereof, or a combination thereof. The alkali metal may be Na, K, or Li. An amount of such thickener used may be 0.1 parts by weight to 3 parts by weight based on 100 parts by weight of the negative electrode active material. The cellulose-based compound may also act as a binder.

The binder is not limited thereto, and any binder used in the relevant technical field may be used, and the amount of the binder may also be appropriately adjusted.

The conductive material is used to provide conductivity to the electrode, and may include, for example, a carbon-based material such as natural graphite, artificial graphite, carbon black, acetylene black, ketjen black, a carbon fiber, and a carbon nanotube; a metal-based material in the form of metal powder or metal fibers, including copper, nickel, aluminum, and silver; a conductive polymer such as a polyphenylene derivative; or a mixture thereof.

The negative electrode current collector may be selected from a copper foil, a nickel foil, a stainless steel foil, a titanium foil, a nickel foam, a copper foam, a polymer substrate coated with a conductive metal, and a combination thereof.

If the negative electrode layer is a negative electrode catalyst layer, it means that the negative electrode is a deposition-type negative electrode. The deposition-type negative electrode means a negative electrode that does not include a negative electrode active material if the battery is assembled, but in which lithium metal or the like is precipitated if the battery is charged and this acts as a negative electrode active material. To explain this in more detail, if charging an all-solid-state battery, lithium ions are deintercalated from the positive electrode active material, pass through the solid electrolyte, and move toward the negative electrode, and are deposited on the negative electrode current collector, resulting in the formation of a lithium deposition layer between the current collector and the negative electrode layer. A negative electrode having such a lithium deposition layer is called a deposition-type negative electrode.

That is, a lithium deposition layer may be formed between the negative electrode current collector and the negative electrode layer.

The charging process may be a formation process performed 1 to 3 times at 0.05 C to 1 C at about 25° C. to 50° C.

A thickness of the lithium deposition layer may be 10 μm to 50 μm. For example, the thickness of the lithium deposition layer may be greater than or equal to 10 μm, greater than or equal to 20 μm, greater than or equal to 30 μm, or greater than or equal to 40 μm and less than or equal to 50 μm, less than or equal to 40 μm, less than or equal to 30 μm, or less than or equal to 20 μm. If the thickness of the lithium deposition layer is within the above range, there may be an advantage in that lithium may be reversibly precipitated during charge/discharge, thereby further improving the cycle-life.

The negative electrode catalyst layer may include a metal, a carbon material, or a combination thereof that acts as a catalyst. In the negative electrode catalyst layer, for example, a metal may be supported on a carbon material, or a metal and a carbon material may be present in a mixture. In an embodiment, the negative electrode catalyst layer may include a metal and a carbon material.

The carbon material may be, for example, crystalline carbon, amorphous carbon, or a combination thereof, and may be amorphous carbon. The crystalline carbon may be, for example, natural graphite, artificial graphite, mesophase carbon microbeads, or a combination thereof.

In an embodiment, the amorphous carbon and the metal particles may be mixed, or the metal particles may be supported on the amorphous carbon.

The amorphous carbon may be, for example, carbon black, acetylene black, denka black, ketjen black, furnace black, activated carbon, graphene, or a combination thereof. An example of the carbon black is Super P (Timcal). The amorphous carbon is not limited thereto, and anything as amorphous carbon in the relevant field is of course possible.

The amorphous carbon may be a single particle, may have the form of a secondary particle in which a plurality of primary particles are aggregated, or may be a combination thereof.

The particle size of the above single particle may be from 10 nm to 60 mm. In addition, the particle size of the primary particle may be 20 nm to 100 nm, and the particle size of the secondary particle may be 1 μm to 20 μm.

In an embodiment, the particle size of the primary particles may be greater than or equal to 20 nm, greater than or equal to 30 nm, greater than or equal to 40 nm, greater than or equal to 50 nm, greater than or equal to 60 nm, greater than or equal to 70 nm, greater than or equal to 80 nm, or greater than or equal to 90 nm, and less than or equal to 100 nm, less than or equal to 90 nm, less than or equal to 80 nm, less than or equal to 70 nm, less than or equal to 60 nm, less than or equal to 50 nm, less than or equal to 40 nm, or less than or equal to 30 nm.

In an embodiment, the particle size of the secondary particles may be greater than or equal to 1 μm, greater than or equal to 3 μm, greater than or equal to 5 μm, greater than or equal to 7 μm, greater than or equal to 10 μm, or greater than or equal to 15 μm, and less than or equal to 20 μm, less than or equal to 15 μm, less than or equal to 10 μm, less than or equal to 7 μm, less than or equal to 5 μm, or less than or equal to 3 sum.

The shape of the primary particles may be spherical, elliptical, plate-shaped, and combinations thereof. In an embodiment, the shape of the primary particles may be spherical, elliptical, and a combination thereof.

The metal particles may be any one selected from Ag, Zn, Al, Sn, Mg, Ge, Cu, In, Ni, Bi, Au, Si, Pt, Pd, and a combination thereof and in an embodiment may be Ag. If the negative electrode catalyst layer includes the metal particles, the electrical conductivity of the negative electrode may be improved.

The metal particles may have a size of 5 nm to 800 nm. The size of the metal particles may be greater than or equal to 5 nm, greater than or equal to 50 nm, greater than or equal to 100 nm, greater than or equal to 150 nm, greater than or equal to 200 nm, greater than or equal to 250 nm, greater than or equal to 300 nm, greater than or equal to 350 nm, greater than or equal to 400 nm, greater than or equal to 450 nm, greater than or equal to 500 nm, greater than or equal to 550 nm, greater than or equal to 600 nm, greater than or equal to 650 nm, greater than or equal to 700 nm, or greater than or equal to 750 nm. In addition, the size of the metal particles may be less than or equal to 800 nm, less than or equal to 750 nm, less than or equal to 700 nm, less than or equal to 650 nm, less than or equal to 600 nm, less than or equal to 550 nm, less than or equal to 500 nm, less than or equal to 450 nm, less than or equal to 400 nm, less than or equal to 350 nm, or less than or equal to 300 nm and less than or equal to 250 nm, less than or equal to 200 nm, less than or equal to 150 nm, less than or equal to 100 nm, or less than or equal to 50 nm. If the size of the metal particles is within the above range, the battery characteristics (e.g., cycle-life characteristics) of the all-solid-state battery may be improved.

If the negative electrode catalyst layer includes a carbon-based material and metal particles, a mixing ratio of the carbon-based material and the metal particles may be a weight ratio of 1:1 to 99:1. For example, the weight of the carbon-based material to the metal particles may be greater than or equal to 1, greater than or equal to 2, greater than or equal to 3, greater than or equal to 4, greater than or equal to 5, greater than or equal to 10, greater than or equal to 15, greater than or equal to 20, greater than or equal to 25, greater than or equal to 30, greater than or equal to 35, greater than or equal to 40, greater than or equal to 45, greater than or equal to 50, greater than or equal to 55, greater than or equal to 60, greater than or equal to 65, greater than or equal to 70, greater than or equal to 75, greater than or equal to 80, greater than or equal to 85, greater than or equal to 90, or greater than or equal to 95, and less than or equal to 99, less than or equal to 95, less than or equal to 90, less than or equal to 85, less than or equal to 80, less than or equal to 75, less than or equal to 70, less than or equal to 65, less than or equal to 60, less than or equal to 55, less than or equal to 50, less than or equal to 45, less than or equal to 40, less than or equal to 35, less than or equal to 30, less than or equal to 25, less than or equal to 20, less than or equal to 15, less than or equal to 10, less than or equal to 5, less than or equal to 4, less than or equal to 3, or less than or equal to 2. For example, the weight ratio of the carbon-based material to the metal particles may be 1:1 to 5:1, 1:1 to 10:1, 1:1 to 20:1, 1:1 to 30:1, 1:1 to 40:1, 1:1 to 50:1, 1:1 to 60:1, 1:1 to 70:1, 1:1 to 80:1, or 1:1 to 90:1. If the carbon-based material and the metal particles are included in the above weight ratio, the electrical conductivity of the negative electrode may be further improved.

Additionally, the negative electrode active material layer may further include a binder, a conductive material, and/or a solid electrolyte. The binder and the conductive material are the same as those described in the negative electrode active material layer.

The solid electrolyte may be an inorganic solid electrolyte such as a sulfide-based solid electrolyte or an oxide-based solid electrolyte described above for the positive electrode, or a solid polymer electrolyte. The solid electrolyte included in the positive electrode may be the same as or different from the solid electrolyte included in the positive electrode.

The negative electrode catalyst layer may further include an additive such as a filler, a dispersant, and an ion conductive material. In addition, known materials generally used in all-solid-state batteries may be used as a filler, a dispersant, an ion conductive material, etc. that may be included in the negative electrode catalyst layer.

A thickness of the negative electrode catalyst layer may be, for example, 1 μm to 500 μm, 1 μm to 200 μm, 1 μm to 100 μm, or 1 μm to 50 μm, but is not limited thereto.

The current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil or sheet.

The electrolyte layer may include a solid electrolyte. The solid electrolyte may be an inorganic solid electrolyte such as a sulfide-based solid electrolyte, an oxide-based solid electrolyte, a halide-based solid electrolyte, or a solid polymer electrolyte.

The sulfide-based solid electrolyte and the oxide-based solid electrolyte are as described above, and may be the same as or different from the solid electrolyte included in the positive electrode or the negative electrode.

The halide-based solid electrolyte may include a Li element, an M element (M is a metal other than Li), and an X element (X is a halogen). Examples of X may include F, Cl, Br, and I. In particular, in the halide-based solid electrolyte, at least one of Br and Cl is suitable as the above X. In addition, examples of M may include metal elements such as Se, Y, B, Al, Ga, and In.

A composition of the halide-based solid electrolyte is not particularly limited, but may be represented by Li₆₋₃ₐMₙBr_{b}Cl_{c} (where M is a metal other than Li, 0<a<2, 0≤b≤6, 0≤c≤6, and b+c=6). At this time, a may be 0.75 or more, 1 or more, and a may be 1.5 or less. The b may be 1 or more, and may be 2 or more. Additionally, the c may be 3 or more, and may be 4 or more. Specific examples of the halide-based solid electrolyte may be Li₃YBr₆, Li₃YCl₆, or LiYBr₂C₄.

The solid electrolyte layer may further include a binder. At this time, the binder may be a styrene butadiene rubber, polytetrafluoroethylene, polyvinylidene fluoride, polyethylene, an acrylate-based polymer, or a combination thereof, but is not limited thereto, and anything used as a binder in the art may be used. The acrylate-based polymer may be butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof. A forming process of the solid electrolyte layer is well known in the art, and thus a detailed description thereof will be omitted.

A thickness of the solid electrolyte layer may be, for example, 10 μm to 150 μm.

The solid electrolyte layer may further include an alkali metal salt, and/or ionic liquid, and/or a conductive polymer.

The alkali metal salt may be for example a lithium salt. An amount of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBFA, LiBF₃(C₂F₅), lithium bis(oxalato) borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiFSI, LiN(SO₂F)₂), LiCF₃SO₃, LiAsF₆, LiSbF₆, LiClO₄, or a mixture thereof.

In addition, the lithium salt may be an imide type, and for example, the imide type lithium salt may include lithium bis(trifluoro methanesulfonyl)imide (LiTFSI, LiN(SO₂CF₃)₂), lithium bis(fluorosulfonyl)imide (LiPSI, LiN(SO₂F)₂). The imide-based lithium salt may maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃C₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state battery may be improved.

An all-solid-state battery according to an embodiment may be fabricated by sequentially stacking a positive electrode, a solid electrolyte, and a negative electrode to prepare a stack, adhering an elastic sheet to the outer surface of the positive electrode and/or negative electrode, and then pressing it. The pressing may be performed at a temperature of, for example, 25° C. to 90° C., and may be performed at a pressure of less than or equal to 550 MPa, or less than or equal to 500 MPa, for example, 400 MPa to 500 MPa. The pressing may be for example an isostatic press, a warm isostatic press, a roll press, or a plate press.

Under these pressing conditions, the aforementioned elastic sheet may be compressed at an appropriate ratio of 30% to 60% compared to the initial thickness, and may be compressed, and a restoring rate of the elastic sheet may satisfy a ratio of 35% to 80% compared to the initial thickness.

The all-solid-state rechargeable battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery is not particularly limited, and may be, for example, a coin type, a button type, a sheet type, a stack type, a cylindrical shape, a flat type, and the like. In addition, the all-solid-state battery may be applied to medium and large-sized batteries used in electric vehicles and the like. For example, the all-solid-state battery may also be used in a hybrid vehicle such as a plug-in hybrid electric vehicle (PHEV). In addition, it may be applied to an energy storage system (ESS) requiring a large amount of power storage, and may also be applied to an electric bicycle or power tool.

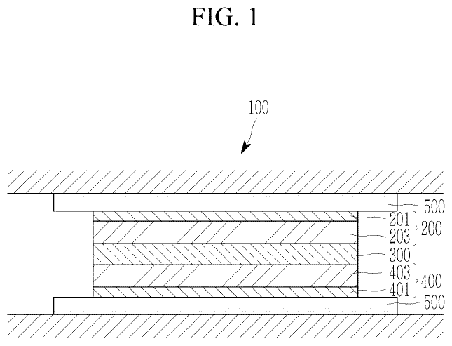

FIG. 1 is a cross-sectional view of an all-solid-state battery according to an embodiment. Referring to FIG. 1, the all-solid-state battery 100 includes an electrode assembly in which a negative electrode 400 including a negative electrode current collector 401 and a negative electrode active material layer 403, a solid electrolyte layer 300, a positive electrode 200 including a positive electrode active material layer 203 and the positive electrode current collector 201; and an elastic layer 500 on the outer surface of at least one of the positive electrode 200 and the negative electrode 400 are stacked and a case such as a pouch housing the electrode assembly. Although FIG. 1 shows one electrode assembly including the negative electrode 400, the solid electrolyte layer 300, and the positive electrode 200, an all-solid-state battery may also be manufactured by stacking two or more electrode assemblies.

The all-solid-state battery 100 is fabricated by pressing the electrode stack in the manufacturing process, and has a structure in which charging and discharging proceeds in a pressed state.

FIG. 1 illustrates a structure in which an elastic sheet 500 is located on the outermost layer of an electrode assembly, but is not limited thereto, and as explained above, in a structure in which two or more electrode assemblies are stacked, the elastic sheet may be located on the outermost layer and/or inside the assembly.

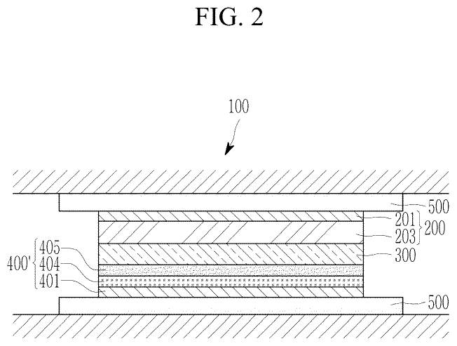

FIG. 2 is a schematic cross-sectional view of an all-solid-state battery including a deposition-type negative electrode. Referring to FIG. 2, the precipitation-type negative electrode 400′ may include a current collector 401 and a negative electrode active material layer 405 on the current collector. In an all-solid-state battery having such a precipitation-type negative electrode 400′, a high-density lithium metal or the like may be precipitated between the current collector 401 and the negative electrode catalyst layer 405 during initial charging, thereby forming a lithium precipitation layer 404. Accordingly, in an all-solid-state battery that has been charged more than or equal to once, the deposition-type negative electrode 400′ may include a current collector 401, a lithium deposition layer 404 on the current collector, and a negative electrode catalyst layer 405 on the lithium deposition layer. The lithium deposition layer 404 refers to a layer in which lithium metal, etc. is precipitated during the charging process of the battery, and may be referred to as a metal layer or a negative electrode active material layer.

The charging process may be a formation process performed 1 to 3 times at 0.05 C to 1 C at about 25° C. to 50° C.

A thickness of the lithium precipitation layer may be 10 μm to 50 μm. For example, the thickness of the lithium precipitation layer may be greater than or equal to 10 μm, greater than or equal to 20 μm, greater than or equal to 30 μm, or greater than or equal to 40 μm, and less than or equal to 50 μm, less than or equal to 40 μm, less than or equal to 30 μm, or less than or equal to 20 μm. If the thickness of the lithium precipitation layer is within the above range, there may be an advantage in that lithium may be reversibly precipitated during charge/discharge, thereby further improving cycle-life.

### Mode for Performing the Invention

Hereinafter, examples of the present invention and comparative examples are described. These examples, however, are not in any sense to be interpreted as limiting the scope of the invention.

### Example 1

### (1) Manufacturing of Elastic Sheet

A multilayer elastic sheet was manufactured by stacking each 125 μm-thick acrylic resin film, on both surfaces of a 50 μm-thick urethane film manufactured from polyurethane resin. The acrylic resin film was manufactured using 2-ethylhexyl acrylate acrylic resin. In the manufactured elastic sheet, a thickness ratio of the urethane film thickness:the acrylic resin film (total thickness of the two acrylic resin films) was 1:5.

### (2) Manufacturing of Positive Electrode

A positive electrode composition was prepared by mixing 85 wt % of LiNi_{0.8}Co_{0.15}Mn_{0.05}O₂ positive electrode active material coated with Li₂O—ZrO₂, 13.5 wt % of lithium argyrodite-type solid electrolyte Li₆PS₅Cl, 1.0 wt % of a polyvinylidene fluoride binder, and 0.5 wt % of carbon nanotube conductive material in an N-methyl pyrrolidone solvent.

The prepared positive electrode composition was coated on an aluminum positive electrode current collector using a bar coater, dried, and compressed to manufacture a positive electrode.

### (3) Manufacturing of Solid Electrolyte Layer

An argyrodite-type solid electrolyte, Li₆PS₅Cl (D50=3 μm), was added to the binder solution in which an acrylic binder (SX-A334, Zeon) was dissolved in an isobutyl isobutyrate (IBIB) solvent, was stirred in a Thinky mixer to adjust the viscosity to an appropriate level, and a 2 mm zirconia ball was added followed by stirring again in the Thinky mixer to prepare a slurry. In the prepared slurry, an amount of the solid electrolyte was 98.5 wt %, and an amount of the binder was 1.5 wt %.

The slurry was coated on a polyethylene release film using a bar coater and dried at room temperature (25° C.), and then the polyethylene release film was removed to prepare a solid electrolyte layer.

### (4) Manufacturing of Negative Electrode

Carbon black having a primary particle size (D50) of about 30 nm and silver (Ag) having an average particle size (D50) of about 60 nm were mixed in a weight ratio of 3:1, 0.25 g of the mixture was added to 2 g of an N-methyl pyrrolidone solution including 7 wt % of a polyvinylidene fluoride binder, and the mixture was mixed to prepare a negative electrode active material layer composition.

The negative electrode active material layer composition was coated on a nickel foil current collector using a bar coater and vacuum dried to manufacture a negative electrode.

(5) Fabricating of all-Solid-State Battery Cell

The manufactured positive electrode, solid electrolyte layer, and negative electrode were cut, and the positive electrode, solid electrolyte layer, and negative electrode were stacked in that order, and then, the positive electrode and the manufactured elastic sheet on the negative electrode were stacked respectively to manufacture an assembly.

The assembly was placed in a laminate film and pressed with a force of 5000 gf to fabricate an all-solid-state battery cell.

In the pressed state, the thickness of the positive electrode active material layer was about 100 μm, the thickness of the negative electrode active material layer was about 7 μm, the thickness of the solid electrolyte layer was about 60 μm, and the thickness of the elastic sheet was about 120 μm.

### Example 2

An all-solid-state battery cell was fabricated in the same manner as in Example 1, except that an acrylic resin film each having a thickness of 100 μm was stacked on both surfaces of a urethane film. At this time, the thickness ratio of the urethane film and the acrylic resin film layer was 1:4.

### Example 3

An all-solid-state battery cell was fabricated in the same manner as in Example 1, except that an acrylic resin film each having a thickness of 150 μm was stacked on both surfaces of a urethane film. At this time, the thickness ratio of the urethane film and the acrylic resin film layer was 1:6.

### Comparative Example 1

An all-solid-state battery cell was fabricated in the same manner as in Example 1, except that an acrylic resin film each having a thickness of 75 μm was stacked on both surfaces of a urethane film. At this time, the thickness ratio of the urethane film and the acrylic resin film layer was 1:3.

### Comparative Example 2

An all-solid-state battery cell was fabricated in the same manner as in Example 1, except that a silicone resin film having a thickness of 300 μm was used as an elastic sheet.

### Comparative Example 3

An all-solid-state battery cell was fabricated in the same manner as in Example 1, except that a urethane film having a thickness of 300 μm made of polyurethane resin was used as an elastic sheet.

### Comparative Example 4

An all-solid-state battery cell was fabricated in the same manner as in Example 1, except that an acrylic resin film having a thickness of 300 μm manufactured from 2-ethylhexyl acrylate was used as an elastic sheet.

The compositions of the elastic sheets of Examples 1 to 3 and Comparative Examples 1 to 4 are shown in Table 1. In Table 1, the thickness ratio is a ratio of the thickness of the first layer of acrylic resin:(the second layer+the third layer of urethane-based resin).

### Experimental Example 1) Evaluation of Δ Tan δ Value

The multi-frequency-strain module, i.e., the loss modulus (E″) and the storage modulus (E′) of the elastic sheets of Examples 1 to 3 and Comparative Examples 1 to 4 were measured using DMA-Q800 (TA Instruments) by the following method.

After cutting the elastic sheet to a width of 10 mm, the cut elastic sheet was placed between two jigs, and the screws of the jigs were tightened to 15 N to secure the elastic sheet. At this time, the distance between the two jigs was set to 11.5 mm.

The E″ and E′ values at 25° C. and the E″ and E′ values at 45° C. were obtained by measuring under the conditions of a strain of 0.15% and a frequency of 1 Hz while increasing the temperature from −40° C. to 80° C. at a rate of 5° C./min.

From this result, Δ Tan δ of Equation was obtained, and the results are shown in Table 4.

$$Δ Tan δ = ( Tan 25 value at 25 ° C . ) - ( Tan 45 value at 45 ° C . ) \qquad [ Equation 1 ]$$

$$( In Equation 1 , Tan 25 value is E {25}^{′′} / E {25}^{′} and Tan 45 value is {E 45}^{′′} / E {45}^{′} )$$

$$Δ Tan δ = Tan {δ}_{T = 25} - Tan {δ}_{T = 45}$$

$$In Equation 1 , Tan {δ}_{T = 25} is {E}^{′′} / {E}^{′} at 25 ° C . , wherein {E}^{′′} is the loss modulus and {E}^{′} is the storage modulus ,$$

$$and$$

$$Tan {δ}_{T = 45} is {E}^{′′} / {E}^{′} at 45 ° C . , wherein {E}^{′′} is the loss modulus and {E}^{′} is the storage modulus .$$

### Experimental Example 2) Cycle-Life Evaluation

The all-solid-state battery cells of Examples 1 to 3 and Comparative Examples 1 to 4 were charged and discharged at 0.33 C to evaluate their cycle-life. Charge and discharge were considered as one cycle, with one charge at 0.33 C; and one discharge at 0.33 C, and the cycle-life was defined as the cycle in which the discharge capacity became 60% of the discharge capacity of one cycle. The results are shown in Table 1.

TABLE 1

| | | | | | Comparative | Comparative | Comparative | Comparative |
|---|---|---|---|---|---|---|---|---|
| | | Example 1 | Example 2 | Example 3 | Example 1 | Example 2 | Example 3 | Example 4 |
| Elastic | | Three- | Three- | Three- | Three- | Single | Single | Single |
| sheet | | layer | layer | layer | layer | layer | layer | layer |
| structure | | | | | | | | |
| Thickness | | 1:5 | 1:4 | 1:6 | 1:3 | — | — | — |
| ratio | | | | | | | | |
| 25° C. | E′(MPa) | 24.3 | 80.5 | 11.5 | 103.9 | 2.4 | 41.8 | 13.4 |
| | E″(MPa) | 9.1 | 16.0 | 5.2 | 21.0 | 0.2 | 14.4 | 9.3 |
| | Tan | 0.37 | 0.20 | 0.45 | 0.20 | 0.09 | 0.35 | 0.69 |
| | delta | | | | | | | |
| 45° C. | E′(MPa) | 9.9 | 32.9 | 8.0 | 23.4 | 2.4 | 9.6 | 4.0 |
| | E″(MPa) | 1.8 | 2.7 | 1.3 | 5.7 | 0.2 | 3.0 | 1.2 |
| | Tan | 0.18 | 0.08 | 0.16 | 0.24 | 0.10 | 0.31 | 0.29 |
| | delta | | | | | | | |

| | | | | | | | |
|---|---|---|---|---|---|---|---|
| Cycle-life (cycle) | 340 | 150 | 100 | 0 | 0 | 30 | 30 |
| ΔTanδ | 0.20 | 0.12 | 0.29 | −0.04 | −0.01 | 0.03 | 0.40 |

As shown in Table 1, in the case of Comparative Example 1, similar to Examples 1 to 3, it has a three-layer structure, but the thickness ratio of the urethane film to the acrylic resin film layer is 1:3, so that the Δ Tan δ value is too small, and as a result, the cycle-life characteristics are 0, i.e., charging and discharging are not possible.

In this regard, in the case of Example 2, where the thickness ratio of the urethane film to the acrylic resin film layer is 1:4 and the Δ Tan δ value is 0.12, charging and discharging is possible, and in the case of Example 1, where the thickness ratio of the urethane film to the acrylic resin film layer is 1:5 and the Δ Tan δ value is 0.20, the cycle-life is improved.

From these results, as the ratio of the acrylic resin film layer increases, E′ decreases at 25° C. and Tan delta (=E″/E′) increases, which alleviates the impact applied to the solid electrolyte in the pressing process during the fabrication of an all-solid-state battery cell, enabling charging and discharging of the battery cell and improving its cycle-life.

Additionally, in the case of Example 3 where the Δ Tan δ value is 0.29, cycle-life characteristics are improved.

In the case of Comparative Example 3, where a urethane film manufactured from polyurethane resin was used as an elastic sheet, the 25° C. Tan delta value was similar to Example 1, but the 45° C. Tan delta value was greater than that of Example 1, and in this case, the force with which the elastic sheet is compressed and then restored was small, so that the decrease in close-contacting force between components of the all-solid-state battery increased, resulting in a significantly reduced cycle-life.

In addition, Comparative Examples 2 and 4, which are single-layer structures, also showed significantly deteriorated cycle-life characteristics due to Δ Tan δ values being too low or too high.

From these results, it may be clearly seen that, regardless of the value range of each of 25° C. Tan delta and 45° C. Tan delta, excellent cycle-life characteristics are exhibited if the difference between these values, Δ Tan δ, is greater than or equal to 0.12 and less than 0.40.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An elastic sheet for an all-solid-state battery having
a Δ Tan δ value of greater than or equal to 0.12 and less than 0.40, as defined by Equation 1.
$$Δ Tan δ = Tan {δ}_{T = 25} - Tan {δ}_{T = 45} \qquad [ Equation 1 ]$$
(in Equation 1, Tan δ_{T=25} is E″/E′ at 25° C., wherein E″ is the loss modulus and E′ is the storage modulus, and
Tan δ_{T=45} is E″/E′ at 45° C., wherein E″ is the loss modulus and E′ is the storage modulus)

2. The elastic sheet for an all-solid-state battery as claimed in claim 1, wherein the Δ Tan δ value is greater than or equal to 0.12 and less than 0.34.

3. The elastic sheet for an all-solid-state battery as claimed in claim 1, wherein the elastic sheet has a single-layer structure or a multilayer structure.

4. The elastic sheet for an all-solid-state battery as claimed in claim 1, wherein the elastic sheet has a multilayer structure.

5. The elastic sheet for an all-solid-state battery as claimed in claim 1, wherein the elastic sheet includes an acrylic resin, a urethane-based resin, or a combination thereof.

6. The elastic sheet for an all-solid-state battery as claimed in claim 1, wherein the elastic sheet includes
a first layer including an acrylic resin and
a second layer including a urethane-based resin and a third layer including a urethane-based resin on both surfaces of the first layer.

7. The elastic sheet for an all-solid-state battery as claimed in claim 6, wherein a thickness ratio of the first layer and (a total thickness of the second layer and the third layer) is 1:4 to 1:6.

8. An all-solid-state battery, comprising:
a positive electrode;
a negative electrode;
a solid electrolyte layer between the positive electrode and the negative electrode; and
the elastic sheet as claimed in claim 1, on an outer surface of at least one of the positive electrode and the negative electrode.
